(19) United States
(12) Patent Application Publication
(10) Pub. No.: US 2006/0170840 A1
(43) Pub. Date: Aug. 3, 2006

(54) Surface light source unit, liquid crystal display device having the same, and method for emitting light

(75) Inventors: Cheol-jin Park, Suwon-si (KR); Kyoung-geun Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/257,078

(22) Filed: Oct. 25, 2005

(30) Foreign Application Priority Data
Feb. 1, 2005 (KR) 10-2005-0009134

(51) Int. Cl. G02F 1/1335

(52) U.S. Cl. 349/61

(57) ABSTRACT

A surface light source unit, a liquid crystal display apparatus, and a method for reducing snaking and vibration of the positive column caused in the surface light source unit are provided. The surface light source unit includes at least one discharge space for emitting light, a first electrode positioned a distance apart from the center of one side of the discharge space for emitting current, and a second electrode positioned at a distance apart from the center of the other side of the discharge space for receiving the current emitted from the first electrode. The first electrode and the second electrode disposed at both sides of the discharge space arranged on the upper side of the surface light source unit are positioned at the upper side of the center of the discharge space. The first electrode and the second electrode positioned at both sides of the discharge space arranged on the lower side of the surface light source unit are positioned apart from the center of the discharge space. Therefore, snaking and the vibration of the positive column are reduced. A black portion generated in the upper and lower side of the conventional surface light source unit is also reduced.

### CROSS-REFERENCE TO RELATED APPLICATIONS

This application claims benefit under 35 U.S.C. § 119 from Korean Patent Application No. 2005-9134, filed on Feb. 1, 2005, the entire content of which is incorporated herein by reference.

### BACKGROUND OF THE INVENTION

1. Field of the Invention

The present invention relates to a surface light source unit, an electrode structure of a liquid crystal display device having the same, and a method for emitting light.

2. Description of the Related Art

A Liquid Crystal Display (LCD) is a type of a flat-panel display device for displaying characters, images and motion pictures corresponding to data processed by an information processing apparatus by controlling liquid crystals.

An LCD device needs an additional light source unit since it is an element which cannot emit light by itself, unlike display devices having a self-light-emitting property, such as a cathode ray tube.

As a light source unit, a light emitting diode emitting one-dimensional light and a cold cathode fluorescent lamp (CCFL) emitting two-dimensional light are mainly used. However, since the light emitting diode and the CCFL have poor brightness uniformity, an optical member such as a diffusion sheet and a prism sheet is required to use the light emitting diode and the CCFL as the light source unit.

However, both of the light emitting diode and the CCFL are disadvantageous in light efficiency since the optical member described above causes an optical loss. They further have a drawback that production cost is high and the brightness uniformity is deteriorated due to the complexity in their structure.

To solve such problems, a surface light source unit which emits surface light directly, has recently been suggested. The surface light source unit includes a surface light source body with an internal structure, which is divided into a plurality of discharge spaces, and external electrodes arranged at both ends of the surface light source body to apply a discharge voltage.

In the surface light source unit, a plasma discharge is caused in each discharge space when the discharge voltage is externally applied to the electrodes. An ultraviolet ray is generated due to the plasma discharge, and the ultraviolet ray is changed into a visible ray by a fluorescent layer coated on the inner wall of the surface light source unit.

FIG. 1 illustrates an electrode structure of a surface light source unit in accordance with a related art. Referring to FIG. 1, the surface light source unit includes a first electrode part 100, a second electrode part 104, and a discharge part composed of a plurality of discharge spaces 102. The first electrode part 100 includes a plurality of first electrodes and the second electrode part 104 includes a plurality of second electrodes. A current exit from the first electrode of the first electrode part 100 of the surface light source unit, passes through the discharge space 102 and flows into the second electrode of the second electrode part 104. Referring to FIG. 1, each of the first electrodes of the first electrode part 100 is arranged in the center portion of one side of the corresponding discharge space 102, and each of the second electrodes in the second electrode part 104 is also arranged in the center portion of the other side of the corresponding discharge space 102.

FIG. 2 shows the drawbacks associated with an arrangement where each of the first electrode 200 constituting the surface light source unit is arranged in the center of one side of the discharge space 210. Since a surface light source unit discharges as an external electrode type, the discharge path is unstable at an initial stage and it takes a predetermined time for the discharge path to be stable. In such a case, a ‘snaking’ phenomenon that the current moves in zigzag in the discharge space 210, is caused due to the unstable state of the discharge path. That is, in a case where the current exiting from the first electrode 200 is weak, the current does not flow straight into the second electrode 202, but flows into the second electrode 202 in a zigzag pattern.

Further, for each discharge space 210, 212, it takes different times for the discharge paths in discharge spaces 210 and 212 to be stable due to the impedance difference. As is shown in FIG. 2, while the discharge path of the lower discharge space 212 is stable, the discharge path of the upper discharge space 210 is still unstable. In this case, the current exiting from the first electrode 200 of the upper discharge space 210, which has an unstable discharge path, does not move straight within the upper discharge space 210, but flows into the second electrode 202 of the upper discharge space 210 by passing through the lower discharge space 212 instead of the upper discharge space 210. That is, in case that it takes different times for the discharge paths to be stable, a vibration phenomenon of a positive column that the current moves to pass through a plurality of discharge spaces in zigzag is caused. Once the discharge reaches a stable state, since the current flows straight through the center portion of the discharge space, such snaking phenomenon and vibration phenomenon of the positive column are not observed. The snaking phenomenon and the vibration phenomenon of the positive column are observed as the light moves in a zigzag pattern on a display. Accordingly, elimination of the snaking and vibration of the positive column, generated in the conventional surface light source unit, is desirable.

### SUMMARY OF THE INVENTION

The present invention addresses the above and other drawbacks associated with the related art.

In accordance with an exemplary embodiment of the present invention, a method for emitting light is provided where snaking and vibration of a positive column caused in the conventional surface light source units is reduced.

In accordance with another exemplary embodiment of the present invention, a method for emitting light is provided where the snaking and the vibration of the positive column caused in the conventional surface light source units at an initial stage of a discharge is reduced, thereby increasing light efficiency of a surface light source unit.

In accordance with another exemplary embodiment of the present invention, there is provided a surface light source unit comprising at least one discharge space for emitting light, a first electrode positioned at a position apart from the center of one side of the discharge space by a predetermined distance for emitting current, and a second electrode positioned at a position which is apart from the center of the other side of the discharge space by a predetermined distance for receiving the current emitted from the first electrode.

In accordance with another exemplary embodiment of the present invention, the first electrode and the second electrode positioned both sides of the discharge space arranged on the upper side of the surface light source unit may be disposed at an upper portion of a discharge space part with respect to the center portion of the discharge space part.

In accordance with another exemplary embodiment of the present invention, the first electrode and the second electrode positioned at both sides of the discharge space arranged on the lower side of the surface light source unit may be disposed at a lower portion of the discharge space part with respect to the center portion of the discharge space part.

In accordance with another exemplary embodiment of the present invention, there is provided a liquid crystal display device comprising a support case having a support frame with a window, an liquid crystal display panel arranged in the support case for displaying an image using incident lights, and a surface light source unit accommodated into the support case for emitting light to the liquid crystal display panel, wherein the surface light source unit comprises at least one discharge space for emitting light, a first electrode positioned at a position apart from the center of one side of the discharge space by a predetermined distance for emitting current, and a second electrode positioned at a position which is apart from the center of the other side of the discharge space by a predetermined distance for receiving the current emitted from the first electrode.

### BRIEF DESCRIPTION OF THE DRAWINGS

The above exemplary aspects and features of the present invention will be more apparent by describing certain embodiments of the present invention with reference to the accompanying drawings, in which like reference symbols indicate the same or similar components, wherein:

FIG. 1 is a view showing an electrode structure of a surface light source unit in accordance with a related art;

FIG. 2 is a view for explaining the problems caused due to the electrode structure of surface light source unit in accordance with the related art;

FIG. 3 is an exploded perspective view of an LCD device according to an exemplary embodiment of the present invention;

FIG. 4 is a perspective view of the surface light source unit shown in FIG. 3;

FIG. 5 is a rear perspective view showing the rear side of the surface light source unit shown in FIG. 3;

FIG. 6 is a view showing an electrode structure of the surface light source unit according to an exemplary embodiment of the present invention; and

FIG. 7 is a view showing that the current exiting from the first electrode of the surface light source unit flows into the second electrode, according to an exemplary embodiment of the present invention.

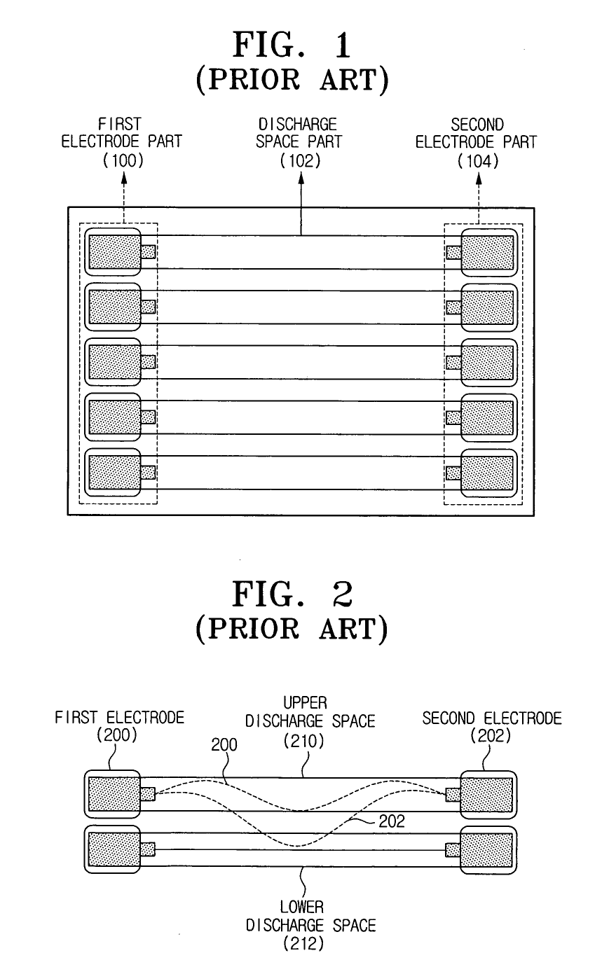

### DETAILED DESCRIPTION OF EXEMPLARY EMBODIMENTS

An electrode structure of LCD device having a surface light source unit according to exemplary embodiments of the present invention will be described in detail with reference to the accompanying drawings.

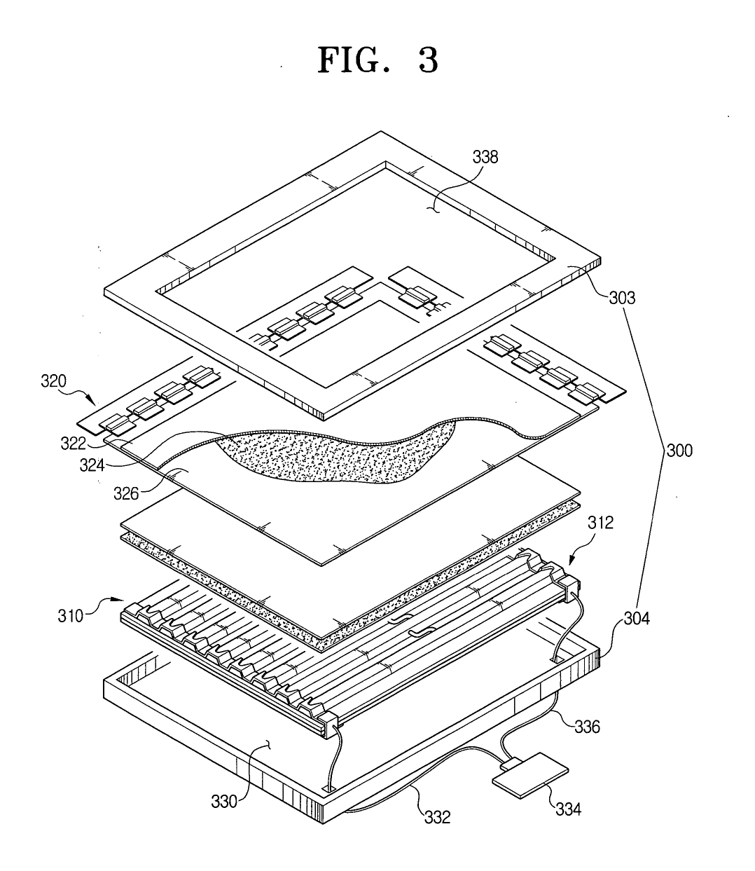

FIG. 3 is an exploded perspective view of an LCD device according to an embodiment of the present invention. Referring to FIG. 3, an LCD device according to an exemplary embodiment comprises a surface light source unit 310, an LCD panel 320, and a support case 300.

The support case 300 includes a case body 304, in which the surface light source unit 310 and the LCD panel 320 are accommodated, and a support frame 303 arranged on the upper part of the case body 304 for covering peripheral areas of the surface light source unit 310 and the LCD panel 320. The support frame 303 is a square frame shape and has a window 338 at the center thereof.

The surface light source unit 310 is accommodated in a reception unit 330 of the case body 304. The distinctive technical features of the surface light source unit 310 will be discussed below in detail with reference to other drawings. The surface light source unit 310 is electrically coupled to the external power source 334 by power feed lines 332 and 336.

The LCD panel 320 includes a Thin Film Transistor (TFT) substrate 326, a color filter substrate 322 facing and combined with the TFT substrate 326, and liquid crystals 324 arranged between the substrates 322 and 326. The LCD panel 320 converts light emitted from the surface light source unit 310 to image light with information.

Since the LCD panel 320 is vulnerable to an external shock, four sides thereof are covered and protected by the support frame 303 so that the panel is not separated.

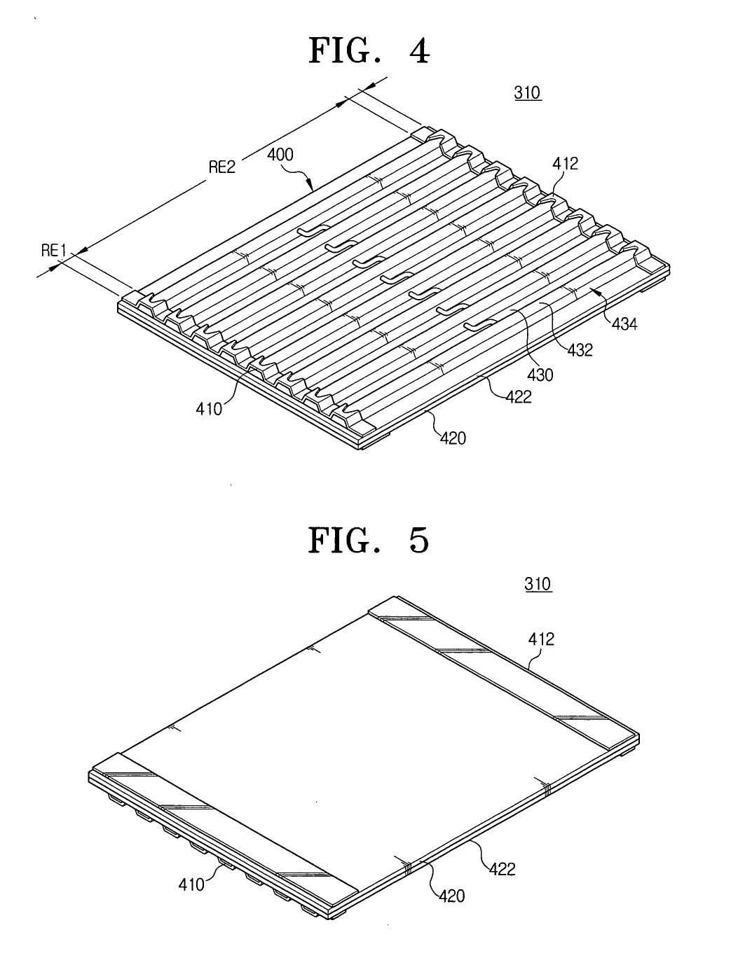

FIG. 4 is a perspective view of the surface light source unit shown in FIG. 3. Referring to FIG. 4, the surface light source unit includes a surface light source body 400, a first electrode part 410 and a second electrode part 412 which are arranged on both ends of the surface light source body 400.

The body 400 includes a first substrate 420 and a second substrate 422 which are stacked. The first substrate 420 has a flat panel shape, and it is made of a transparent glass substrate which allows a visible ray to pass there through and interrupts an ultraviolet ray.

The second substrate 422 is spaced apart from the first substrate 420 and is a non-flat panel shape, thereby having a plurality of discharge spaces 432 and a plurality of space divisions 430 thereon. The cross-section of the second substrate 422 has a contour such that a plurality of semi-ovals similar to trapezoidal shapes consecutively arranged. But, the cross-sectional shape of the second substrate 422 is not limited to this but includes various modifications thereof, such as a semi-circle, a quadrangle and so on, are within the scope of the present invention.

A discharge part 434 is composed of a plurality of discharge spaces 432 and a plurality of space divisions 430. The space divisions 430 are disposed between the discharge spaces 432, thereby dividing the discharge part 434 into a plurality of the discharge spaces 432. The second substrate 422 is formed of the same transparent glass substrate as the first substrate 420.

After the first substrate 420 and the second substrate 422 are bonded together, air existing in the discharge spaces 432 is exhausted and thus the discharge spaces 432 are evacuated. Next, a discharge gas capable of causing plasma discharge is injected into the discharge spaces 432. The gas pressure of the discharge gas is different from the external atmospheric pressure.

Meanwhile, the discharge part 434 of the body 400 of the surface light source unit is divided into a first region RE1 which is covered by the support frame 303 and therefore is not exposed to outside and a second region RE2 which is not covered by the support frame 303 and corresponds to the window 338. The second region RE2 is an effective light-emitting area where a visible ray is emitted due to a plasma discharge caused in the discharge part 434 of the body 400 of the surface light source unit.

There are a plurality of first electrodes 410 and a plurality of second electrodes 412 in the surface light source unit and the current exit from the first electrodes 410 flows into the second electrodes 412.

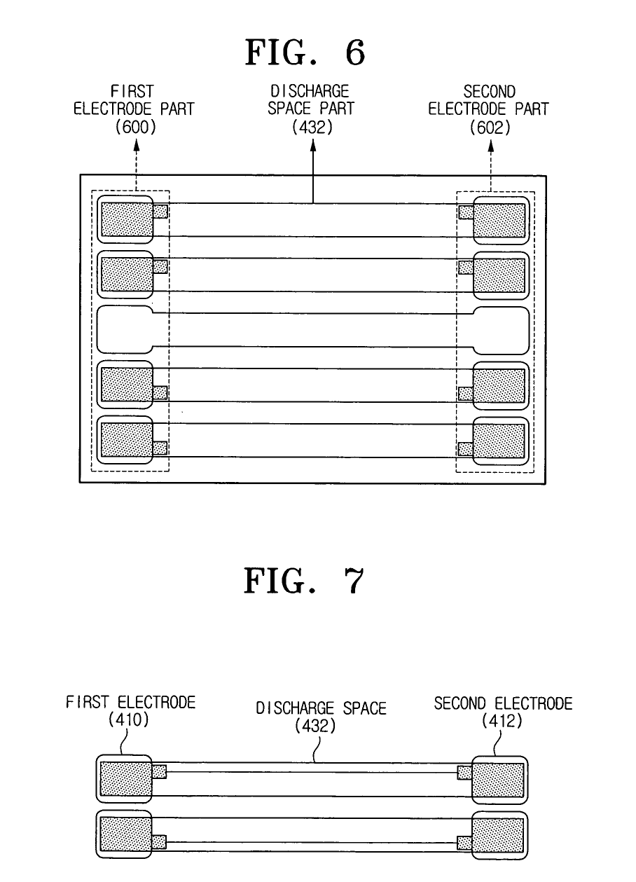

FIG. 6 is a view showing an electrode structure of the surface light source unit according to an exemplary embodiment of the present invention. Referring to FIG. 6, an electrode structure of the surface light source unit will be explained in detail below.

Referring to FIG. 6, the surface light source unit includes a first electrode part 600, a second electrode part 602, and a discharge part composed of a plurality of discharge spaces 432. The first electrode part 600 includes a plurality of first electrodes 410, and the second electrode part 602 includes a plurality of second electrodes 412. The current output from the first electrodes 410 flows into the second electrodes 412 via the corresponding discharge spaces 432.

The first electrodes 410 and the second electrodes 412 are not arranged at the center portion of both sides of the corresponding discharge spaces 432, respectively, and arranged at positions distanced from the center by a predetermined distance. In particular, the first electrodes 410 and the second electrodes 412 arranged on the upper side of an LCD device are disposed at an upper portion of the corresponding discharge spaces in the vertical direction with respect to the center of the corresponding discharge spaces. The first electrodes 410 and the second electrodes 412 arranged on the lower side of an LCD device are disposed at a lower portion of the corresponding discharge spaces with respect to the center. Referring to FIG. 6, the first electrode 410 and the second electrode 412 arranged on the upper side of an LCD device are positioned on the upper portions of the corresponding discharge spaces 432, respectively. That is, each of the first electrode 410 and each of the second electrode 412 arranged on the upper side of an LCD are disposed apart from the center portion of each of the discharge space 432, specifically positioned at the upper side of the center. The first electrode 410 and the second electrode 412 arranged on the lower side of an LCD device are positioned at the lower side from the center of the discharge space 432. These are merely exemplary non-limiting embodiments of the present invention. That is, other arrangements where, for example, first electrode 410 and second electrode 412 are arranged at a position apart from the center portion of the discharge space 432 by a distance are within the scope of the present invention.

FIG. 7 is a view showing the state that the current output from the first electrode 410 flows into the second electrode 412 via the discharge space 432, in a case that the first electrode 410 and the second electrode 412 are disposed at a position which is apart from the center of the discharge space 432 by a predetermined distance. As is shown in FIG. 7, if the first electrode 410 and the second electrode 412 are arranged at a position apart from the center of the discharge space 432 by a predetermined distance, the current output from the first electrode 410 flows into the second electrode 412 straight, in, for example, a linear pattern. That is, if the first electrode 410 and the second electrode 412 are arranged at a position apart from the center of the discharge space 432 by a predetermined distance, snaking and the vibration of the positive column are reduced.

In accordance with exemplary embodiments of the present invention, in the surface light source unit and the LCD device as described above, the first electrode and the second electrode are arranged at a position apart from the center of the discharge space by a predetermined distance, so that snaking and the vibration of the positive column can be reduced. In an exemplary implementation of the present invention, the first electrode and the second electrode arranged on the upper side of an LCD device are positioned at an upper side of the center of the discharge space. The first electrode and the second electrode arranged on the lower side of an LCD device are positioned at the lower side of the center of the discharge space. Therefore, a black portion of the LCD device is reduced.

The foregoing embodiment and advantages are merely exemplary and are not to be construed as limiting the scope of the present invention. It will be understood by those skilled in the art that the present teaching can be readily applied to other types of implementations, and many alternatives, modifications, and variations will be apparent the those skilled in the art.

What is claimed is:

1. A surface light source unit comprising,
at least one discharge space for emitting light;
a first electrode positioned at a first distance from the center of one side of the discharge space for emitting current; and
a second electrode positioned at a second distance from the center of another side of the discharge space for receiving the current emitted from the first electrode.

2. The surface light source unit according to claim 1, wherein the first electrode and the second electrode are arranged at an upper side of the center of the discharge space.

3. The surface light source unit according to claim 2, wherein the discharge space is arranged on the upper side of the surface light source unit.

4. The surface light source unit according to claim 1, wherein the first electrode and the second electrode are arranged at a lower side of the center of the discharge space.

5. The surface light source unit according to claim 4, wherein the discharge space is arranged on the lower side of the surface light source unit.

6. A liquid crystal display apparatus comprising,
a support case comprising a support frame comprising a window;
a liquid crystal display panel arranged with respect to the support case for displaying an image using incident light; and
a surface light source unit accommodated into the support case for emitting light to the liquid crystal display panel;
wherein the surface light source unit comprises:
at least one discharge space for emitting light;
a first electrode positioned at a first distance from the center of one side of the discharge space for emitting current; and
a second electrode positioned at a second distance from the center of another side of the discharge space for receiving the current emitted from the first electrode.

7. The liquid crystal display apparatus according to claim 6, wherein the first electrode and the second electrode are arranged at an upper side of the center of the discharge space.

8. The liquid crystal display apparatus according to claim 7, wherein the discharge space is arranged on the upper side of the surface light source unit.

9. The liquid crystal display apparatus according to claim 6, wherein the first electrode and the second electrode are arranged at a lower side of the center of the discharge space.

10. The liquid crystal display apparatus according to claim 9, wherein the discharge space is arranged on the lower side of the surface light source unit.

11. The surface light source unit according to claim 1, wherein the first distance is approximately equal to the second distance.

12. The liquid crystal display apparatus according to claim 6, wherein the first distance is approximately equal to the second distance.

13. A method for emitting light from a surface light source unit, the method comprising:
positioning a first electrode at a first distance from the center of one side of a discharge space; and
positioning a second electrode at a second distance from the center of another side of the discharge space;
applying power to at least one of the first and second electrodes to emit current from the at least one of the first and second electrodes to the other of the first and second electrodes.

14. The method according to claim 13, wherein the first electrode and the second electrode are positioned at an upper side of the center of the discharge space.

15. The method according to claim 14, further comprising arranging the discharge space on the upper side of a surface light source unit.

16. The method according to claim 13, wherein the first electrode and the second electrode are positioned at a lower side of the center of the discharge space.

17. The method according to claim 16, further comprising arranging the discharge space on the lower side of a surface light source unit.

18. The method according to claim 13, wherein the first distance is approximately equal to the second distance.
